(19) United States
(12) Patent Application Publication
(10) Pub. No.: US 2019/0116761 A1
(43) Pub. Date: Apr. 25, 2019

(54) Animal Waste Collection Device

(71) Applicant: Derrick Walter, Neptune, NJ (US)

(72) Inventor: Derrick Walter, Neptune, NJ (US)

(21) Appl. No.: 15/788,053

(22) Filed: Oct. 19, 2017

(51) Int. Cl. A01K 23/00

(52) U.S. Cl. CPC A01K 23/00

(57) ABSTRACT

Disclosed is an animal waste collection device comprising a collection garment and a collection pouch assembly. The collection garment comprises a rectangular structure with connector means in each corner. Within the rectangular structure are holes sized and situated to clear the tail and genital regions of an animal when fastened to the animal's hind quarters. The collection garment can also be fastened around the belly of male animals, omitting the hind quarters, for collection from the genital area only. The collection pouch assembly comprises a sealable pouch with detachable tabs. The pouch is inserted into the holes of the collection garment, where it is held in place by its tabs. When waste is collected, the pouch is removed and sealed, and the tabs removed.

### FIELD OF THE INVENTION

This invention relates generally to devices worn by animals, particularly devices worn to collect animal waste, and more particularly devices worn to collect animal waste for medical analysis.

### BACKGROUND OF THE INVENTION

The following is a tabulation of some prior art that appears relevant:

U.S. Patents

| Patent Number | Kind Code | Issue Date | Patentee |
|---|---|---|---|
| 2,173,356 | | 1939 Jan. 3 | Cross |
| 3,090,356 | | 1963 May 21 | Andrisani |
| 3,817,217 | | 1974 Jun. 18 | Matuka |
| 4,444,152 | | 1984 Apr. 24 | Bernardo |
| 5,386,802 | A | 1995 May 5 | Hang-Fu |
| 5,146,874 | A | 1992 Sep. 15 | Vidal |

There have been many devices designed to collect the waste of small animals, primarily to prevent soiling of the environment, or as a convenience to avoid picking up excrement while walking a dog. The mechanisms generally consist of straps which wrap around the animal and position buckets or other forms of containers in the anal-genital region. The strap systems tend to be complicated and time consuming to rig. Animal diapers also exist, generally consisting of one-piece pull-ups with elastic bands, like a human diaper. However, diapers hold waste against the body, soiling and/or saturating the fur, and requiring cleaning of the animal.

Cross, et al., U.S. Pat. No. 2,173,356, issued Jan. 3, 1939 and Andrisani, U.S. Pat. No. 3,090,356, issued May 21, 1963, disclose early, crude embodiments of this idea, consisting of a harness to which buckets or other rigid cylinders are attached, one in the rear, and one underneath (for males). Aside from the difficulty of getting a dog or other small animal to wear a device that would restrict and irritate the body, any collected matter in an open container would almost certainly be ejected by the animal's movements. Matuka, et al.,

U.S. Pat. No. 3,817,217, issued Jun. 18, 1974 discloses an excrement only collection device that attaches to the animal with straps, but incorporates a relatively unobtrusive rear pouch. (See also Bernardo, U.S. Pat. No. 4,444,152, issued Apr. 24, 1984, and Hang-Fu, U.S. Pat. No. 5,386,802, issued May 7, 1995, both of which use bags to collect excrement, varying primarily in bag design and strapping.) Vidal, U.S. Pat. No. 5,146,874, issued Sep. 15, 1992, discloses a pouch system for both excrement and urine using a variety of harness styles. However, in all the illustrated embodiments, the waste receptacle units must be strapped on independently, making the system cumbersome and costlier to manufacture. None of the prior art is designed to preserve waste for medical analysis.

There is need for a simpler, less costly animal waste collection device, and specifically for a device that can be used by veterinarians to collect sterile waste samples. As a veterinary tool, a simple, unobtrusive waste collection garment would be beneficial with animals who would not otherwise cooperate in the manual collection of a specimen. A hybrid system that utilizes diaper-type garments and containers to separate and hold waste away from the body would be an improvement over prior art, being more convenient to attach, and being cleaner. Furthermore, such a design would be particularly useful for medical purposes because waste could be collected directly into sterile, removable vessels for later diagnostic testing.

### SUMMARY OF THE INVENTION

The animal waste collection device comprises, essentially, a garment with at least one hole that wraps around and fastens to an animal, for the collection of waste. A sealable pouch is inserted in the available holes. The pouch is held in place by detachable tabs. After the waste is collected, the pouch is removed and sealed, and the tabs detached. The device is excellent for collecting waste specimens for medical use, but it can also be used as a general waste prophylactic.

### BRIEF DESCRIPTION OF DRAWINGS

FIG. 1 is a perspective of the animal waste collection device.

FIG. 2 is a perspective of the collection pouch assembly.

FIG. 3 is a perspective of the animal waste collection device fitted to a dog.

FIG. 4 is a perspective of the animal waste collection device in an alternate embodiment wherein it is wrapped around the belly only, for male animals.

### DETAILED DESCRIPTION OF INVENTION

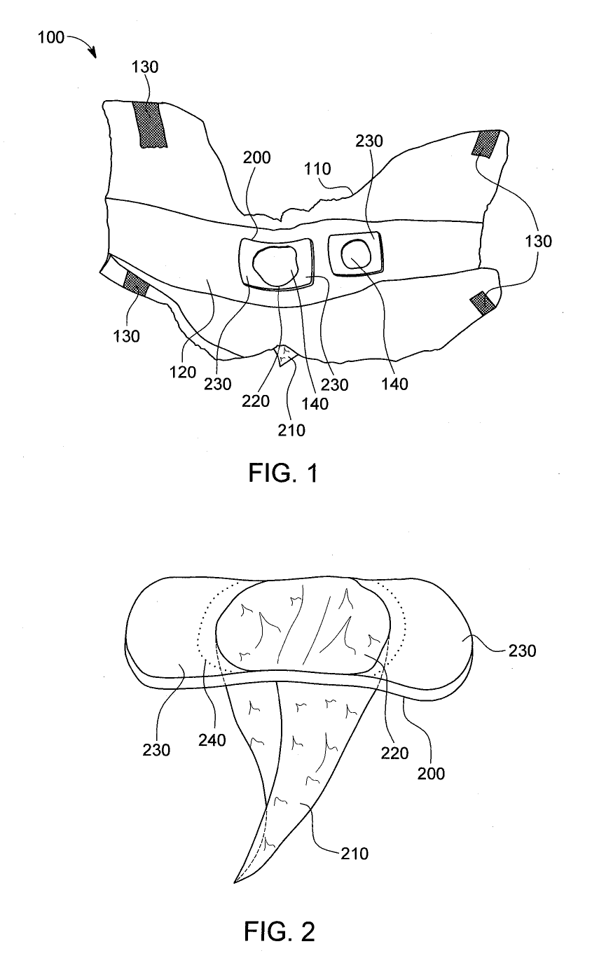

The invention is best understood by reference to the drawings. FIG. 1 shows the preferred embodiment of the animal waste collection device 100, comprising a collection garment 110 and a collection pouch assembly 200. The collection garment is comprised of a rectangular structure 120 with connecting means in each corner 130 for fastening around the animal's hind quarters and waist, and with one or two holes 140, one for males at the tail-anus-genital area, and two for females, one at the tail-anus area and one at the genital area. The connecting means comprises Velcro, snaps, straps, buttons, zippers, or other connecting means well known in the art. A two-hole collection garment is displayed here, which is designed for female animals. Partially displayed is a collection pouch assembly 200 inserted into one of the holes 140 of the collection garment 110. Visible of the collection pouch assembly 200 is a pouch, a pouch opening 220, and a tab 230.

FIG. 2 shows an isolated view of the collection pouch assembly 200, showing the pouch 210, the pouch opening 220, and the tab 230 attached at the pouch opening 220. The pouch opening 220 is sealable by any sealing means well known in the art, an example of which is interlocking groves as made famous by Ziploc. The tab 230 has a detachment means 240. In this figure, the detachment means are perforations for even tearing, but Velcro or other detachment means well known in the art may be used.

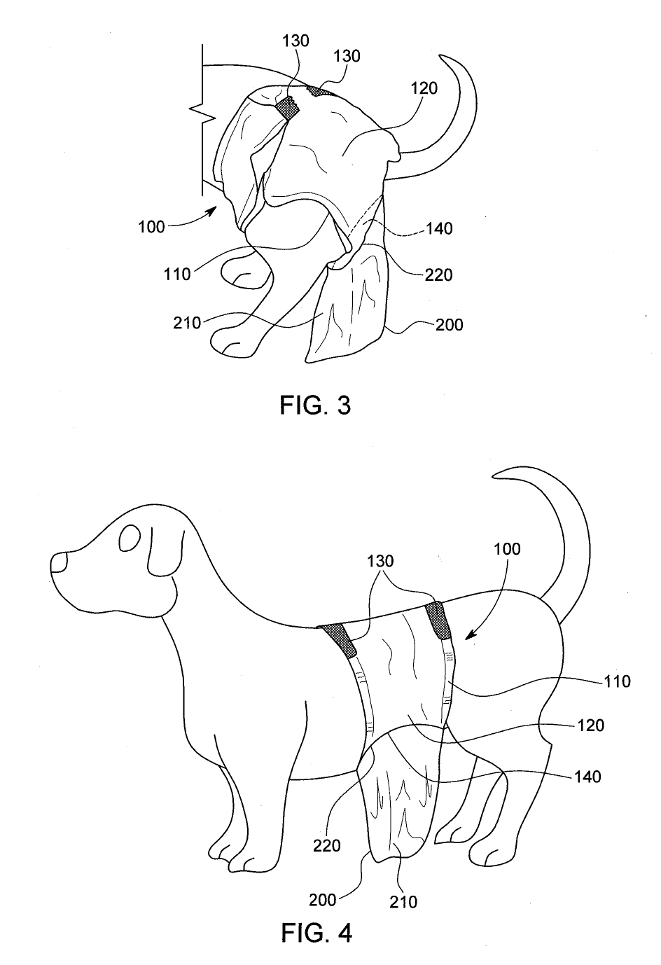

FIG. 3 shows part of the animal waste collection device 100 as worn by a dog. Visible is the collection garment 110 with the rectangular structure 120, the connecting means 130, and the hole 140 for insertion of the collection pouch assembly 200. Visible of the collection pouch assembly 200 is the pouch 210 and the pouch opening 220.

FIG. 4 shows an alternative embodiment of the animal waste collection device 100 being worn by a dog where the collection garment is configured as a belly band, wrapping only around the animal's belly, with no coverage of the tail or hind quarters. Visible is the collection garment 110 with the rectangular structure 120, the connecting means 130, the hole 140, and the collection pouch assembly 200 showing the pouch 210 and the pouch opening 220.

I claim:

1. An animal waste collection device, comprising:
a. a collection garment, comprising a rectangular structure with connecting means in each corner, and two holes situated to align with the tail-anal and the genital regions of a female animal when wrapped and fastened around the animal's hind quarters, and
b. a collection pouch assembly, comprising a pouch with a pouch opening, and at least one tab, said tab comprising a flat structure extending out from the pouch at the pouch opening.

2. An animal waste collection device as claimed in 1, in which the collection garment has one hole, said hole being situated to align with the tail-anal region of an animal.

3. An animal waste collection device as claimed in 1, in which the collection garment has one hole, said hole being situated to align with the genital region of a male animal when the collection garment is fastened around the animal's belly, omitting the hind quarters.

4. An animal waste collection device as claimed in 1, in which the pouch opening has a sealing means.

5. An animal waste collection device as claimed in 1, in which the tab has a detachment means.

6. An animal waste collection device as claimed in 1, in which the collection garment is made of textile, said collection garment being washable and reusable.
